(19) United States
(12) Patent Application Publication
(10) Pub. No.: US 2015/0167355 A1
(43) Pub. Date: Jun. 18, 2015

(54) SYSTEM FOR LOCKING AND UNLOCKING AN OPENING PANEL

(71) Applicant: JPM SAS, Avermes (FR)

(72) Inventors: Gilles COLTEL, Besson (FR); Pascal BERGER, Marigny (FR); Pascal MINET, Saint Menoux (FR)

(21) Appl. No.: 14/566,984

(22) Filed: Dec. 11, 2014

(30) Foreign Application Priority Data
Dec. 13, 2013 (FR) 13 62623

(51) Int. Cl. E05B 65/10; E05C 1/08

(52) U.S. Cl. CPC E05B 65/1066; E05C 1/08

(57) ABSTRACT

A system for locking and unlocking an opening panel includes a mobile bolt and a mobile locking part adapted to cooperate with the bolt, the bolt adapted to occupy a first deployed position in which it is retained by the action of the locking part and a second deployed position in which it is no longer acted on by the locking part. The locking part is designed to occupy a locking position in which it retains the bolt in its first deployed position in the absence of external action on the part and to move from its locking position to an unlocking position by the action of an external force. The system includes a mobile counter-bolt adapted to be deployed and retracted on closing and opening the opening panel and to prevent the locking part returning to its locking position when the bolt is in its second deployed position.

### FIELD OF THE INVENTION

The invention relates to a system for locking and unlocking an opening panel.

### BACKGROUND OF THE INVENTION

There is known from the document EP 1 222 350 a system for locking and unlocking a door that includes a mobile half-turn bolt cooperating with a keeper to exert a locking function when the door is closed. The bolt is held in a locked position against the keeper by the action of a first end of an immobilizing part that occupies a locking first position.

The opposite second end of the part can be actuated to disengage the first end from the part for immobilizing the bolt, thereby enabling the bolt to disengage from the keeper and the door to open.

To be able to reclose the door, the keeper is mounted in a retractable manner in the door frame in order to be able to return the bolt to its locking position when the door is closed again.

However, the system has the notable disadvantage that the keeper must be modified to fit it.

It would be useful to have a system for locking and unlocking a door, or more generally an opening panel, that can be installed with the door without it being necessary to modify the environment of the door and notably the keeper mounted on the door frame.

### SUMMARY OF THE INVENTION

The present invention therefore consists in a system for locking and unlocking an opening panel, the system including:
a mobile bolt that is adapted to be deployed and to be retracted on closing and opening the opening panel, the bolt being adapted to occupy a first deployed position when the opening panel is closed and a second deployed position when the opening panel is open,
a mobile locking part that is adapted to cooperate with the bolt,

characterized in that the locking part is designed, on the one hand, to occupy a locking position in which it prevents the bolt moving from its first deployed position to its retracted position in the absence of external action on said part and, on the other hand, to move from its locking position to an unlocking position as a result of the action of an external force in order to enable opening of the opening panel, the system including a mobile counter-bolt that is adapted to be deployed and to be retracted on closing and opening the door, the counter-bolt being adapted to prevent the locking part returning from its unlocking position to its locking position when the bolt is in its second deployed position and the opening panel is open.

The combination of the three parts forming the locking/unlocking system is mounted on the opening panel without the keeper needing to be modified (standard keeper, of any shape, without the keeper being retractable). It is even possible for there to be no keeper, the door frame then serving as a keeper if its height is sufficient.

As soon as the opening panel is in the open position the bolt and the counter-bolt are deployed. The counter-bolt acts at the same time on the locking part to prevent it to returning to the locking position and does not prevent retraction of the bolt during the movement of closing the door again.

In accordance with other possible features, separately or in combination with one another:
in its retracted position, the bolt is adapted to prevent the locking part returning to its locking position;
the locking part includes a first attachment element and the counter-bolt includes a second attachment element, the first attachment element being placed on the path of the second attachment element and adapted to come into abutment against it when the counter-bolt moves from its retracted position to its deployed position and the bolt moves to its second deployed position;
the locking part includes a first part adapted to cooperate with the bolt and a second part adapted to receive an external force; the external force may be exerted from one side of the opening panel on an anti-panic bar with which the locking part is caused to cooperate or, on the opposite side of the locking panel, on a half-assembly (handle) that is connected to a nut with which the locking part is caused to cooperate;
the bolt and the counter-bolt are each mounted on the same first rotation shaft and are adapted to pivot about the rotation shaft independently of each other over a given angular range of rotation;
the system includes first spring means that are adapted to exert on the bolt and the counter-bolt a spring force tending to retain them in the deployed position;
the locking part is mounted on a second rotation shaft parallel to the first rotation shaft and is adapted to pivot about the second rotation shaft;
the system includes second spring means that are adapted to exert on the locking part a spring force tending to retain it in the locking position;
the first spring means are adapted to exert on the counter-bolt a force greater than the force exerted by the second spring means;
at least one of the two elements comprising the bolt and the counter-bolt includes a stop that is placed on the trajectory of the other element upon pivoting movement of the bolt from a deployed position, the stop being arranged so that, on the one hand, the bolt and the counter-bolt pivot independently of each other from a deployed position over the given angular range of rotation and, on the other hand, beyond this angular range, the bolt comes into contact with the counter-bolt via the stop and drives said counter-bolt in the continuation of the pivoting movement;
the bolt includes a front face intended to cooperate with a keeper and a so-called immobilizing rear face configured to cooperate with the locking part;
the locking rear face has a concavity that is oriented towards the locking part and centred on a so-called centring shaft for centring the rear face; the rear face with this profile enables orientation of the forces toward the centring shaft;
the centring shaft for centring the immobilizing rear face corresponds to the second rotation shaft of the locking part; the locking forces therefore do not disturb the behaviour of the locking part and the position of the latter remains stable whatever the forces applied to the door;
the front face of the bolt has a convexity that is centred on a so-called centring shaft for centring the front face;
the centring shaft for centring the front face and the first rotation shaft are offset so as to create a pair of forces enabling closing of the opening panel when the front face of the bolt comes into contact with the keeper and/or the door frame on which the keeper is mounted;
on moving from its locking position to its unlocking position and vice versa, the locking part is adapted to cooperate with a linkage element mounted to rotate about a rotation shaft in order to cause it to rotate in one direction or the opposite direction;
the bolt is hollow and receives the counter-bolt inside it, an opening being provided in the bolt for the counter-bolt pass through to cooperate with the keeper.

The invention also consists in an assembly for locking and unlocking an opening panel that includes at least one locking and unlocking system as briefly described above and an anti-panic bar associated with said at least one system and actuation of which causes the locking part to move from its locking position to its unlocking position.

In accordance with other possible features:
the assembly includes a plurality of locking and unlocking systems that are connected to one another by a rotary linkage mechanism that is actuated by the rotation movement of the rotary linkage element referred to above;
the assembly includes a first locking and unlocking system disposed substantially in line with the anti-panic bar and two locking and unlocking systems respectively disposed at the top and bottom of the opening panel and each of which is adapted to be unlocked by actuation of the anti-panic bar.

### BRIEF DESCRIPTION OF THE DRAWINGS

Other features and advantages will become apparent in the course of the following description given by way of nonlimiting example only and with reference to the appended drawings, in which:

FIG. 1 is a diagrammatic general view of the placement on an opening panel of a system in accordance with one embodiment of the invention for locking and unlocking the opening panel associated with an anti-panic bar;

FIG. 2 is a diagrammatic general view to a larger scale of the system and the anti-panic bar from FIG. 1;

FIGS. 3a-c are diagrammatic perspective views to a larger scale and as seen from the different angles of the system for locking and unlocking the opening panel without the anti-panic bar;

FIG. 3d is a detailed representation of the locking or immobilizing part;

FIG. 3e depicts the counter-bolt in its entirety;

FIGS. 4a-b to 16 are successive views showing the implementation of the locking and unlocking system from FIGS. 2 and 3a-c;

FIGS. 17 to 19 show another embodiment of the invention.

As shown in FIG. 1 an assembly 10 for locking and unlocking an opening panel such as a door 12 includes:
a locking and unlocking system 14,
an anti-panic bar 16 associated with the system 14 and cooperating therewith (when a user presses on the bar) to command unlocking of the system 14 and therefore opening of the door 12 relative to the frame 18 (door frame) that surrounds it.

### DETAILED DESCRIPTION OF THE INVENTION

In FIG. 1, the system 14 is in the locking position (the assembly 10 is therefore locked) and the door is held closed.

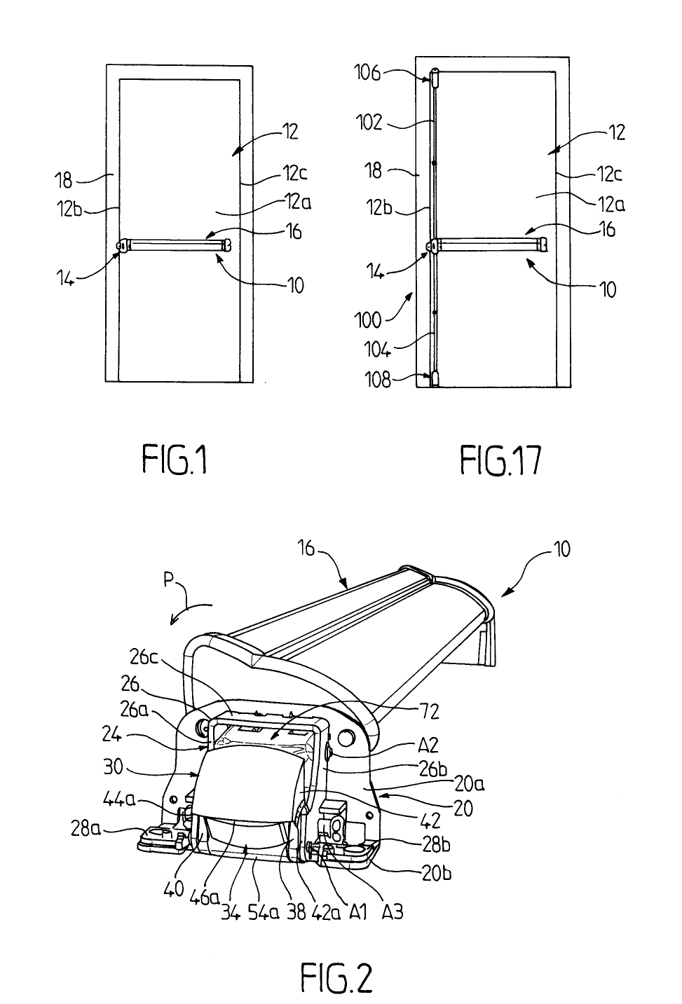

The locking and unlocking assembly 10 is shown in perspective in FIG. 2 without the door and the door frame.

The anti-panic bar 16 of the assembly 10 is mounted on and articulated to pivot about two half shafts 17 fixed to respective shaft supports 20 and 22 at the longitudinal ends of the bar. Only the half-shaft 17 fixed to the shaft support part 20 is shown in FIG. 2.

The shaft support 22 is covered by a cap while the cap of the shaft support 20 that is visible in FIG. 1 has been removed in FIG. 2 to clarify the description.

The shaft support 20 is for example a part with the general shape of a right-angle bracket. The half-shaft 17 of the bar 16 is attached to the part 20a (plate) of the part 20 that is perpendicular to a large face of the door. The part 20b that is parallel to the large face of the door is fixed, for example screwed to the door 12 (screw holes are shown in FIG. 2).

A part 24 referred to as the body is mounted on the shaft support 20. The body 24 includes, on the one hand, a part 26 having a gantry general shape that is back-to-back with the part 20a of the part 20 and, on the other hand, two lateral parts 28a, 28b that extend laterally in the bottom part of the gantry, on either side thereof and toward the outside. The lateral parts 28a, 28b are fixed to the part 20b of the shaft support and serve as bases for fixing the body 24. The part 26 includes two parallel legs 26a, 26b (vertical in FIG. 2) which in the bottom part are connected to the lateral parts 28a, 28b and in the top part are connected by a horizontal wall 26c.

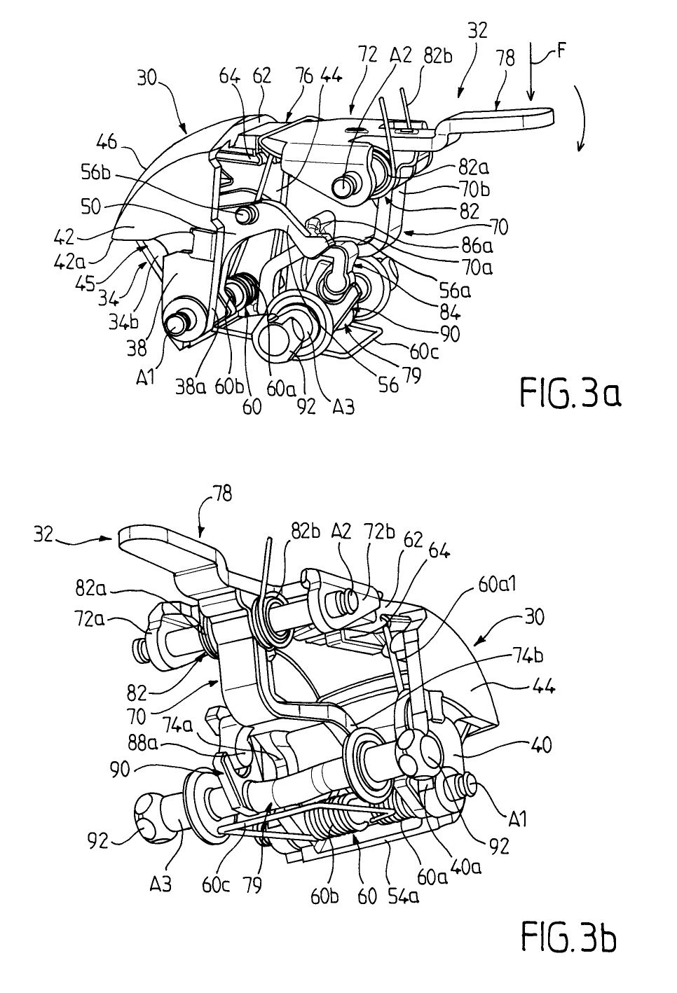

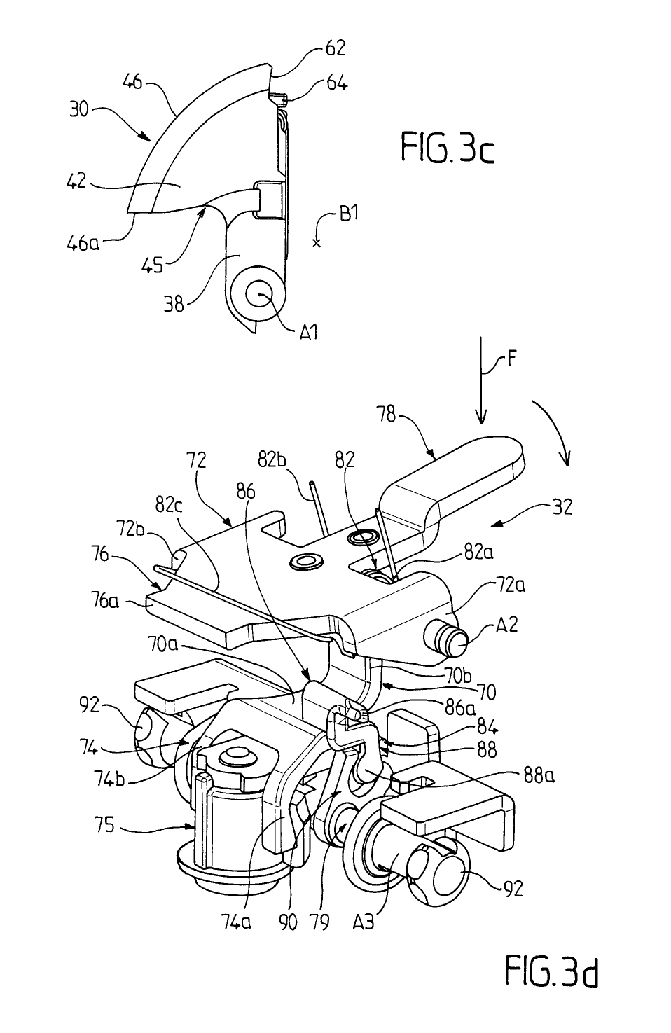

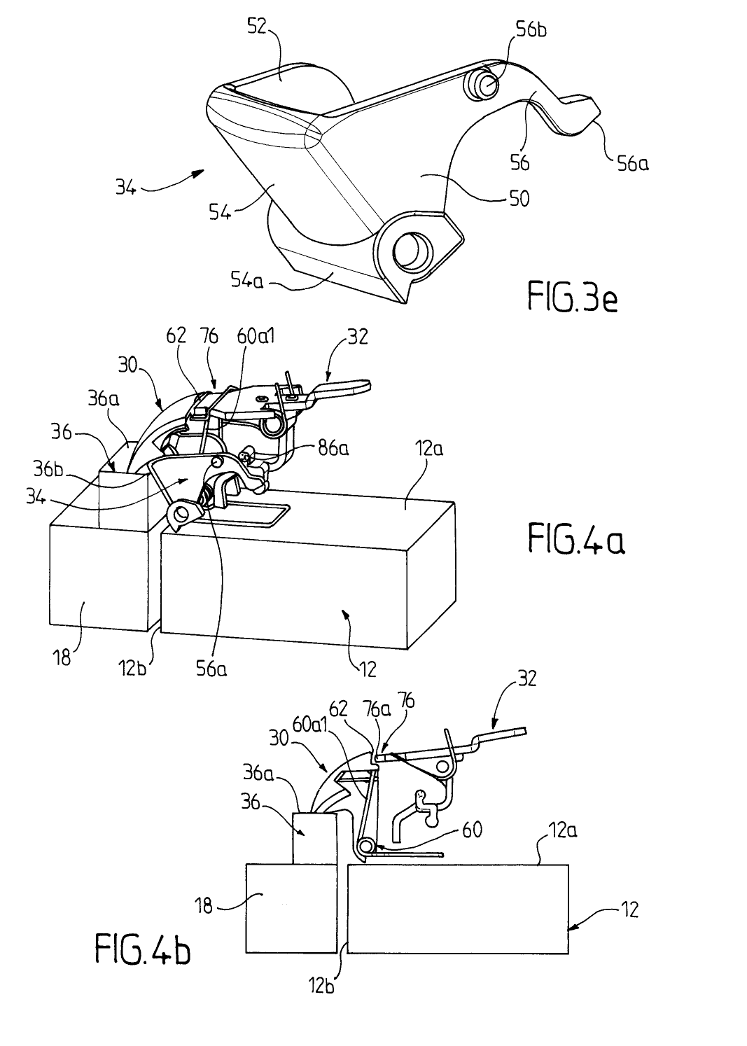

The body 24 serves as a support for fixing the locking and unlocking system 14 that is described next with reference to FIGS. 2 and 3a-c.

FIG. 3a shows the system 14 from FIG. 2 alone, that is to say without the anti-panic bar 16, the body 24 and the shaft support 20.

The system 14 includes:
a mobile bolt 30 that can be deployed, on the one hand, into a first deployed position when it is in a position locking/immobilizing the door (system 14 in locked position) and, on the other hand, into a second deployed position when it is in a position unlocking/releasing the door (system 14 in unlocked position) and the door is opened; the bolt is also able to adopt a retracted position for opening and closing the door;
a mobile locking part 32 that can cooperate with the bolt to prevent its retraction (when the door is locked) in the event of an attempt to open the door without unlocking the part 32; in the absence of attempted opening the bolt is not necessarily in contact with the locking part 32;
a mobile counter-bolt 34 that can be deployed into a deployed position when the bolt is in its second deployed position (door open) and adopt a retracted position for opening and closing the door; the counter-bolt can cooperate with the locking part when opening and closing the door.

The bolt 30 and the counter-bolt 34 are both mounted to rotate about a first pivot shaft A1 parallel to the surface of the large face of the door and the aforementioned elements 20b, 28a and 28b (FIG. 2). The shaft A1 is fixed perpendicularly to the bottom parts of the two parallel legs 26a, 26b of the gantry 26. The axis A1 is oriented vertically in FIG. 1.

The locking part 32 is mounted to rotate about a second pivot shaft A2 parallel to the first shaft A1. The shaft A2 is fixed perpendicularly to the top parts of the two legs 26a, 26b of the gantry 26 (FIG. 2).

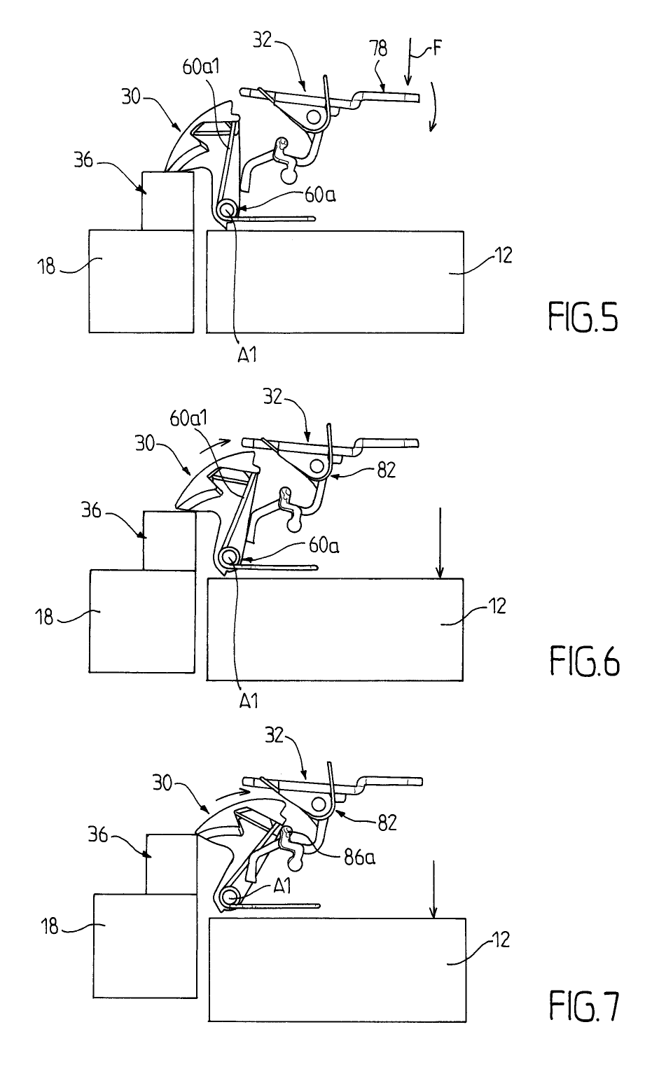

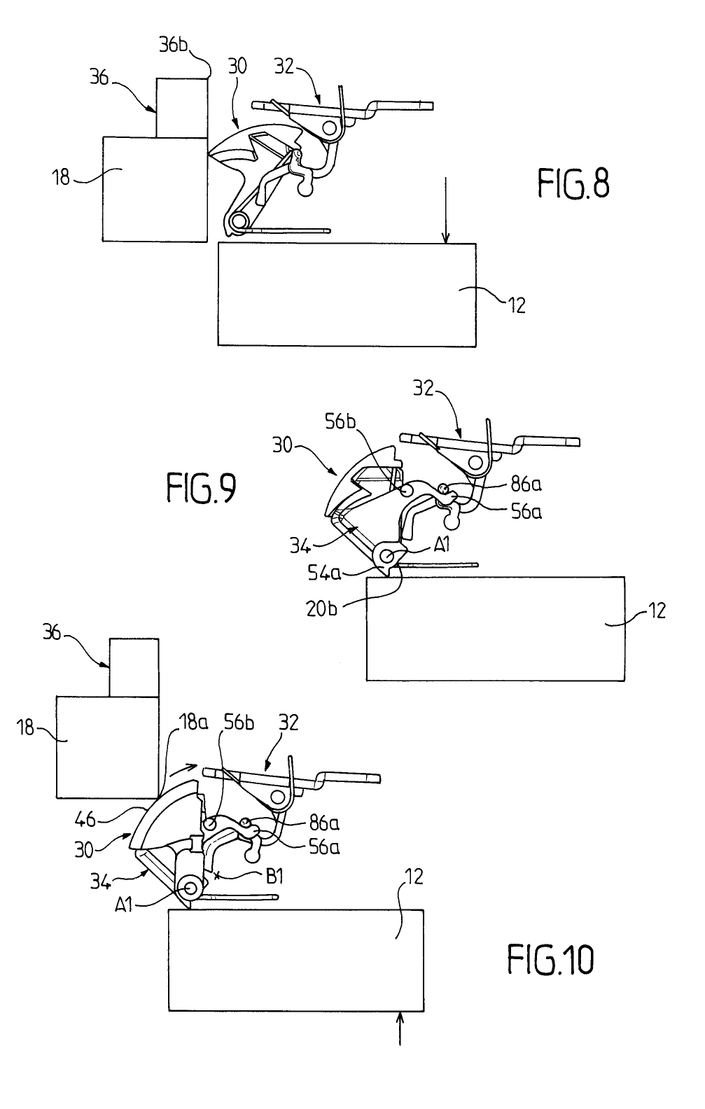

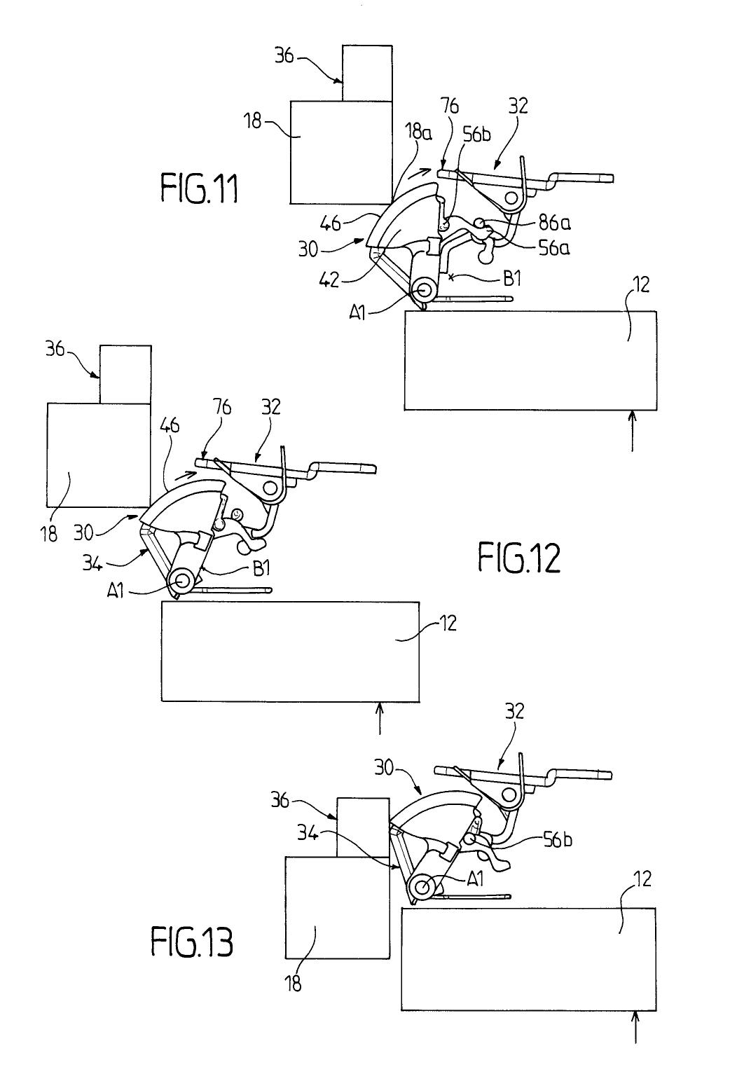

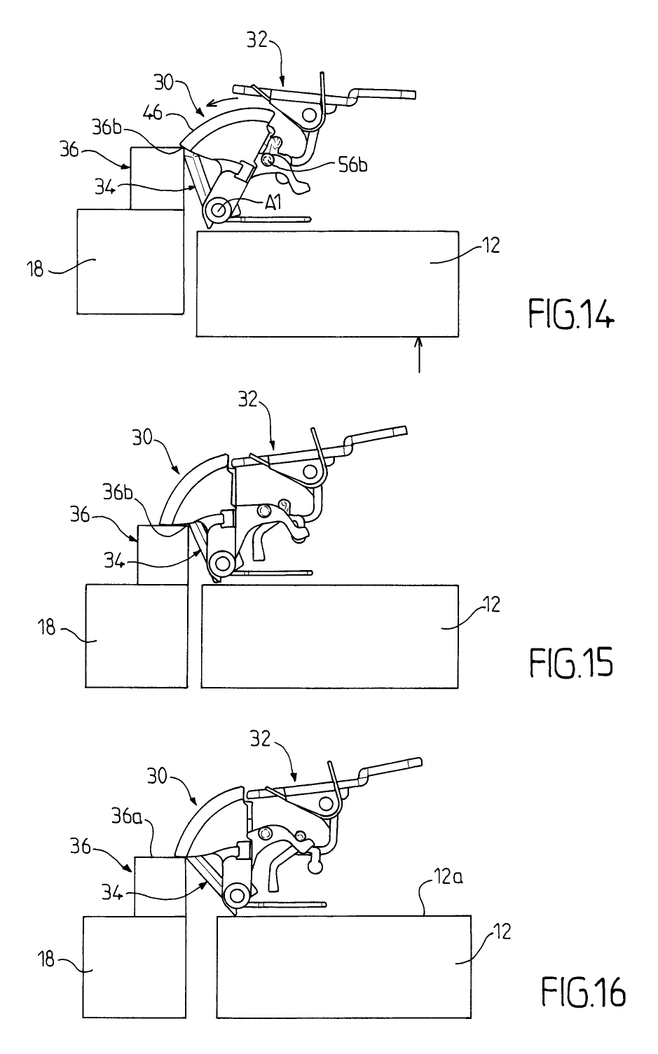

Separate spring means are provided to retain, on the one hand, the bolt 30 and the counter-bolt 34 and, on the other hand, the locking part 32 in a locking position of the system 14 (door closed) that is shown diagrammatically in FIGS. 1 and 4a-b.

In these figures, the system 14 is shown mounted on the large face 12a of the door near one longitudinal vertical edge 12b of the two longitudinal vertical edges 12b, 12c of the door (FIG. 1), facing a keeper 36 fixed to the door frame 18.

One of the two lateral legs of the bolt 30 has been removed in FIGS. 4a-b and 5 to 9 for clarity. In FIG. 4b and the subsequent FIGS. 4b and 5 to 8 the counter-bolt 34 is not shown.

As shown in FIG. 3a, the bolt 30 is a hollow part inside which the counter-bolt 34 is housed.

The bolt 30 includes two parallel lateral arms 38 and 40 through the bottom part of which the shaft A1 is mounted (FIGS. 2 and 3a) perpendicularly to the arms.

The two arms 38, 40 extend in a direction perpendicular to the shaft A1 (upward in FIGS. 2 and 3a) and away therefrom.

The two arms then widen so that each forms a forward part 42, 44 such that the arms and their respective forward part respectively lie in two parallel planes.

Each arm and its forward part have the general shape of a beak or pickaxe head as seen in profile (FIG. 3a) and each forms a lateral leg of the bolt 30.

The two lateral legs are joined on the front face by a domed (convex) front face or wall 46 of arcuate shape that extends from the free front end 42a, 44a of each forward part and upward until vertically in line with the rear free edge 38a, 40a of each arm. As shown in FIG. 3c (side view), the profile of the front face 46 is for example a portion of a circle centred on the centring shaft B1 of the front face. The centring shaft B1 and the first rotation shaft A1 are parallel to each other but offset so as to create a pair of forces for closing the door when the front face 46 of the bolt comes into contact with the keeper 36 and/or the door frame 18 on which the keeper is mounted. In the closed position (FIGS. 4a-b), this offsetting of the shafts also contributes to retaining the bolt 30 in its deployed position in contact with the keeper 36.

The design of the bolt 30 referred to above forms a free space inside the envelope delimited by the lateral legs 38, 42 and 40, 44 and the front wall (front face) 46.

This free space receives the counter-bolt 34 visible in its entirety in FIG. 3e, as well as in FIGS. 3a, 3b and 4a.

The bolt 30 is open in its bottom part situated under the front wall 46 and under each forward part 42, 44 so as to provide an opening 45 in which the counter-bolt 34 is partially inserted.

The front face of the bolt is formed by the (exterior) front face of the front wall 46 and its bottom rim 46a (FIG. 2), the exterior faces of the two arms 38, 40, the bottom faces of the two forward parts 42, 44 and the opening 45.

The counter-bolt 34 is also hollow (FIG. 3e) but is closed over all its front face and its lateral faces, unlike the bolt.

The counter-bolt 34 includes two parallel lateral walls or flanks 50 and 52 through the bottom part of which the shaft A1 is mounted (FIGS. 2 and 3a), perpendicularly to the walls.

The bolt 30 and the counter-bolt 34 are both mounted so as to rotate about the shaft A1 and each can pivot about this shaft independently of the other within certain limits to be defined hereinafter.

As shown in FIGS. 3a, 3e and 4a, each of the lateral walls 50 and 52 is generally V-shaped in profile.

The walls are joined at the front (at the level of their front edge) by a front wall 54 that is also domed (convex). This convexity enables the counter-bolt 34 to establish at the centre of the front wall points of contact with the keeper 36. It will be noted that the front wall 46 of the bolt 30 has a double curvature: a first curvature centred on the central shaft B1 in FIG. 3c (to assist with closing the door) and a second curvature perpendicular to the first that has the same orientation as the curvature of the counter-bolt 34. The respective curvatures with the same orientation of the bolt 30 and the counter-bolt 34 have the same function as described above for the counter-bolt and make it possible to accommodate defects in the alignment of the system 14 (during fitting). Accordingly, even with imperfectly aligned fitting of the system 14 (with a slight skew), the points of contact with the keeper are localized at the centre of the two parts 30 and 34 and there is therefore little disturbance to the functioning of the system 14.

The counter-bolt 34 is disposed inside the bolt 30 so as to project through the opening 45 in the bottom part of the bolt (FIGS. 2 and 3a), below a plane defined by the forward parts 42 and 44 and the bottom free edge 46a (FIG. 2) of the front wall 46.

The counter-bolt 34 configured in this way has the general shape of a wheelbarrow one of the two handles of which has been removed. The front wall 54 of the counter-bolt bears on the keeper 36 from FIG. 4a (door closed) independently of the bolt 30 and therefore serves as a keeper detector.

The counter-bolt 34 also includes an arm 56 that extends toward the rear from the rear top free edge of the lateral wall 50, away from this wall and aligned with it.

The arm 56 has a shape configured so as to form, in a simple manner and with little material, a retaining element intended to cooperate with an attachment element of the locking part 32.

For example, the arm has an undulating shape, namely a shape curved downward and then curved upward at its free end 56a. The upwardly curved free end serves as an element for retaining the counter-bolt 34.

The arm 56 also includes in the vicinity of its base at the lateral wall 50 an element 56b forming a stop. This element 56b (boss) projects laterally outward from the counter-bolt relative to the arm 56 (perpendicularly to the latter and to the wall 50) over a distance that is greater than the lateral separation between the lateral wall 50 and the lateral leg (lateral arm 38 and forward part 42) of the bolt 30. The element 56b is therefore arranged in line with the forward part 42 and therefore on its trajectory upon movement in rotation of the bolt.

It will be noted that the counter-bolt includes in the bottom part of its front wall 54 a dropped edge 54a that is configured to abut against the exterior edge of the plate 20b (FIG. 2) after effecting a pivoting movement about the shaft A1 of predetermined amplitude. This arrangement makes it possible to limit the movement of the counter-bolt when it is deployed (in the event of opening the door).

In accordance with a variant, the arm 56 may alternately be arranged on the lateral wall 52 (the locking part 32 is then configured accordingly).

In accordance with another variant that is not shown the counter-bolt may assume a different shape and notably include an arm that is centred and not localized on one of the two flanks of the counter-bolt.

In accordance with another variant that is not shown the arm may be replaced by a rearward extension of the lateral wall 50, the lateral wall 52 being also extended in a symmetrical manner.

In accordance with another variant that is not shown the retaining element 56b of the arm may be replaced by another type of retaining element or member, necessitating or not consequential modification of the attachment element of the locking part 32.

In accordance with a further variant that is not shown the stop element 56b may be a different shape.

As mentioned above, the system 14 includes elastic means 60 that exert on the bolt 30 and the counter-bolt 34 a force tending to maintain each of them in the deployed position, notably in the first deployed position of the bolt from FIG. 4a (system 14 locked and door closed).

These elastic means 60 (first elastic means) take the form of coil springs 60a, 60b, for example, coiled around the first shaft A1 on the part of the latter disposed inside the counter-bolt 34 (FIGS. 3a and 3b).

A first coil spring 60a is coiled around a first portion of the shaft A1 and includes a branch the free end 60a1 of which bears on a portion of the interior part of the bolt 30 (FIG. 3b) that is configured to lock said free end laterally in a housing. The lateral walls of this housing make it possible to guide the free end 60a1 during subsequent movements of the bolt and the counter-bolt during opening and closing of the door.

A second coil spring 60b is coiled around a second portion of the shaft A1 (longitudinally distant from the first portion) and includes a free end that is not shown that comes to bear against the rear internal face of the counter-bolt 34.

The coil springs 60a and 60b are joined together by a plane branch 60c with the general shape of a frame. This branch bears on the part 20b (plate) of the shaft support part 20 (FIG. 2).

The bolt 30 has in its top part a so-called immobilizing rear face 62 (FIGS. 3a-b) that is profiled or configured to cooperate with the locking part 32. In particular, this rear face features a concavity (visible in FIG. 3c) oriented in the direction of the locking part and centred on a centring shaft coincident with the shaft A2. This configuration therefore makes it possible to transfer to the shaft A2 the forces to which the bolt 30 is subjected. The bolt also includes a central projection 64 that extends away from the interior wall of said bolt and beyond the rear face 62. This projection serves as a possible bearing member for the locking part 32.

The locking or immobilizing part 32 generally includes, notably with reference to FIG. 3d:
a central structure 70 forming a body that is generally substantially L-shaped with a horizontal branch 70a and a vertical branch 70b,
a top structure 72 forming a head mounted at the top end of the vertical branch 70b of the L-shape,
a bottom structure 74 forming parallel legs 74a, 74b that extend downwardly from the free end of the horizontal branch 70a of the L-shape. The legs bear on a nut 75 that receives a square shaft (not shown) passing through the thickness of the door to emerge on the (exterior) face of the door opposite that bearing the anti-panic bar. The square shaft is activated by an exterior half-assembly (a handle that is generally disengaged and necessitates a key to engage it) disposed on the other side of the door if the user wishes to unlock the door from the outside. The head 72 includes a first part 76 that is adapted to cooperate with the rear face 62 of the bolt 30 and a second part 78 that is adapted to receive an exterior force F (FIGS. 3a and 3d). This force is transmitted to the second part 78 via the anti-panic bar 16 when the user presses on the latter.

The locking part 32 is mounted to rotate about the second rotation shaft A2 that passes through the intermediate part of the head 72 between the two parts 76 and 78. The shaft A2 is substantially aligned with the vertical branch 70b of the L-shape and is fixed to two lateral flaps 72a, 72b of the head 72 through which it passes. This shaft is mounted to rotate in the two legs 26a, 26b (FIG. 2).

Second spring means 82 are mounted on the head and around the second shaft A2 in order to exert on the first part 76 of the head a spring force tending to retain the first part 76 in the locking position. Given a functional clearance between the first part 76 (free end 76a thereof) and the immobilizing rear face 62, the locking part is not necessarily in contact with the bolt. This arrangement makes it possible not to favour either over-locking or unlocking. The bolt 30 is therefore immobilized regardless of the angular position of the locking part 32. It will be noted that the free end 76a is convex in order to espouse the shape of the concavity of the rear immobilizing face 62.

The second part 78 forms a lever which, because of the action of the bearing member (F), drives pivoting of the locking part 32 about the shaft A2 as indicated by the arrows in FIGS. 3a and 3d.

More particularly, the spring means 82 take the form of two coil springs 82a, 82b coiled around the shaft A2 on respective opposite sides of the head.

Each of the two springs 82a, 82b has a free end and they are joined at their opposite end by a branch 82c that bears on the top of the first part 76 of the head. Arranged in this way, the spring means 82 exert on the first part 76 (and therefore on the locking part 32) a force that tends to retain the free end 76a in its locking position.

The locking part 32 also includes a lateral structure 84 (laterally offset structure) that extends laterally from the horizontal branch 70a of the L-shape in the direction of the arm 56 of the counter-bolt 34.

The lateral structure 84 includes a top portion 86 that is provided with an attachment element 86a extending laterally in the direction of the arm 56 of the counter-bolt 34. The attachment element 86a has a lateral extension that places it on the path of the retaining element 56a of the arm 56 during the pivoting movement of the counter-bolt 34. The attachment element 86a and the retaining element 56a are therefore caused to cooperate as shown in FIG. 3a upon kinematic interaction of the various parts to be described in detail hereinafter with reference to FIGS. 4a to 14.

The lateral structure 84 also includes a bottom portion 88 the descending free end 88a of which is widened.

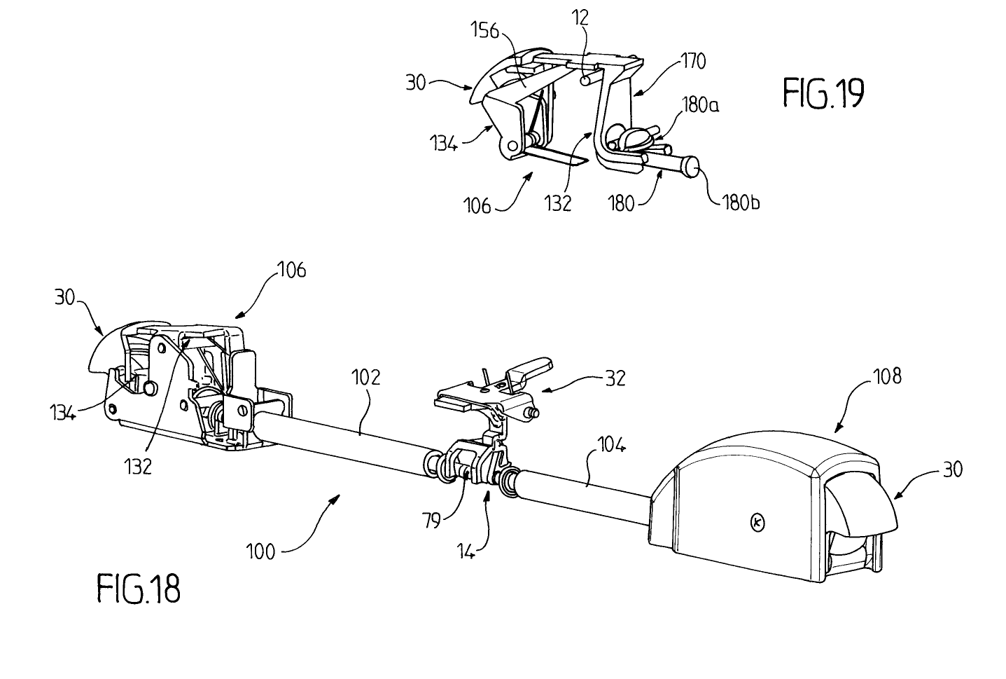

The system 14 also includes a third rotation shaft A3 (parallel to the shafts A1 and A2) in the material form of a bar 79 on which is provided a fork or crank 90 intended to receive the widened portion 88a (FIGS. 3a-b and 3d). The central part of the bar 79 is bent (FIG. 3b) in order not to interfere with the nut 75 shown in FIG. 3b. The combination comprising the shaft A3/bar 79 and the fork forms a linkage element. The linkage element, more particularly the bar 79, includes at each of its two opposite ends a member 92 such as a ball support that is intended to be connected to another linkage element (not shown here but shown in FIGS. 18 and 19). The shaft A3 is also mounted perpendicularly between the two lateral legs 26a and 26b of the gantry 26 and fixed to the latter (FIG. 2).

It will be noted that in the FIG. 1 embodiment (single-point version) the shaft A3 is of no utility. It is used in the multi-point embodiment of FIGS. 17 to 19.

There is described next with reference to FIGS. 4a to 14 the kinematics of the movement of the various component parts of the locking and unlocking system 14 when said system is used to open and to close the door 12.

FIGS. 4a and 4b show the system 14 and its mechanism in the locked position (door closed).

The beak-shaped profile (shoulder) of the bolt 30 is held in its first deployed position pressed against the top face 36a of the keeper 36 by the action of the spring means 60a. The first part 76 of the head 72 of the part 32 is held in its locking position by the action of the spring means 82 facing the profiled rear internal face (immobilizing face) 62 of the bolt 30 and held away from the latter by the functional clearance referred to above. The end 76a of its first part 76 of the locking part 32 therefore serves as a rear stop for the bolt which cannot be retracted by the action of a force applied directly to the door (without using the anti-panic bar 16). In this position, the bolt is in its locking position.

For its part, the counter-bolt 34 (FIG. 4a) is held pressed against the lateral face and/or the top edge 36b of the keeper 36 by the action of the spring means 60b.

In this position, the respective retaining element 56a and attachment element 86a of the counter-bolt 34 and the attachment part 32 do not cooperate.

FIG. 5 shows the unlocking of the system 14 to open the door 12 (the counter-bolt and the shaft A3 are not shown for clarity).

To this end, the user presses in the conventional way on the anti-panic bar 16 from FIGS. 1 and 2, thus causing it to pivot about the half-shaft 17 as indicated by the arrow P in FIG. 2.

The second part 78 of the head of the locking part 32 passes through the wall 20a of the shaft support (this is not shown) and extends under the bar 16 (FIG. 2).

Pressing on the bar causes pressure F on the second bearing part 78 and pivoting of the locking part 32 as indicated in FIG. 5.

The pivoting of the locking part 32 from its locking position (FIGS. 4a-b) to its unlocking position (FIG. 5) causes pivoting of the shaft A3 (bar 79) by way of the cooperation between the widened portion 88a and the fork 90. This movement is of benefit in the FIG. 17 embodiment.

It will be noted that the anti-panic bar 16 comes into abutment with the plate 20a (this is not shown in the figures) and this determines the extreme unlocked position of the locking part 32. This travel limiter device makes it possible to prevent the locking part 32 being subjected to excessive forces (resulting directly from the use of pressing on the bar) so that it is not damaged.

The pivoting of the locking part 32 releases the bolt 30 but the latter remains in its first deployed position by virtue of the action of the spring means 60a. The door 12 is therefore still held in the closed position but becomes maneuverable. The user can therefore continue to press on the anti-panic bar, which is against its stop, and transmit a thrust force to the door via the plates or transmit the thrust force directly to the door with their other hand, as shown by the arrow in FIG. 6.

When the force with which the door is pressed is greater than the force exerted by the spring means 60a on the back of the bolt 30 (retaining force), the beak or shoulder of the bolt 30 slides on the top face 36a of the keeper and is therefore progressively retracted as it pivots about the first shaft A1 (FIG. 6).

The retraction of the bolt 30 during this movement causes the latter to pass under the locking part 32 (FIGS. 6 and 7), which prevents the latter returning to its locking position from FIG. 4a. The locking part 32 is in fact no longer loaded by the action of the use on the anti-panic bar 16 and, acted on by its spring means 82, it would tend to return to its locking position in the absence of the retracted bolt.

The retraction movement of the bolt 30 continuing, the latter comes into contact with the stop element 56b (boss) of the counter-bolt 34 (FIG. 3a) and thus drives retraction movement of the counter-bolt (not shown in FIG. 7).

Pressure on the door continuing (FIGS. 7 and 8), the bolt 30 passes the top edge 36b of the keeper and slides along the latter and then the door frame 18. The counter-bolt (in the retracted position), again not shown, also slides along the keeper and the door frame. The bolt 30 in the retracted position still prevents the locking part 32 returning to the locking position.

When the door opens (FIG. 9), the bolt 30 and the counter-bolt 34 have passed the door frame 18 from FIG. 8 (the latter is located above the bolt and the counter-bolt) and are no longer urged by the latter into their retracted position. They can then be deployed by the action of their respective spring means 60a and 60b and occupy a deployed position (FIG. 9) that is a second deployed position for the bolt and a first deployed position for the counter-bolt (this deployed position is limited by the dropped edge 54a that comes into abutment on the external edge of the plate 20b).

When the counter-bolt 34 moves from its retracted position to its deployed position, the curved (curving) rear part 56a of the arm 56 comes into contact with the finger forming the attachment element 86a of the locking part 32. The finger 86a is then held in the high position by the arm 56, which prevents the part 32 returning to its locking position. In this position in which the bolt is deployed, it is therefore the counter-bolt that immobilizes the locking part.

The bolt 30 can therefore not be immobilized in its second deployed position by the locking part 32.

When a user closes the door (upward arrow in FIG. 10), the bolt 30 comes into contact with the door frame 18 (bottom edge 18a).

Because of the geometry of the bolt 30 (convex front face 46), the latter is progressively retracted by virtue of the contact of its domed front face 46 with the door frame 18. The contact forces between the face 46 and the door frame are oriented toward the shaft B1 (FIG. 3c). The offsetting of the shaft A1 and B1 creates a pair of forces that tend progressively to cause pivoting of the bolt 30 from its deployed position to its retracted position as indicated by the arrow in FIGS. 10 to 12. The bolt 30 is therefore retracted from its second deployed position because the locking part 32 is still held in its unlocking position by the counter-bolt 34.

In that the boss 56b of the counter-bolt is offset angularly relative to the bolt 30 (notably relative to its rear face; see FIG. 3a), movement in rotation of the bolt 30 relative to the shaft A1 independent of that of the counter-bolt 34 is allowed over the angular range that corresponds to the aforementioned angular offset.

The positioning of the boss 56b relative to the rear face of the bolt (rear edge of the forward part 42) is such that, when this rear face comes into contact with the boss, the top part of the front face 46 of the bolt is situated under the first part 76 of the head of the locking part 32 (FIG. 11).

The retraction movement of the bolt 30 therefore in turn drives the retraction movement of the counter-bolt 34 which is then disengaged from the finger 86a of the locking part 32. This part 32 is no longer immobilized by the counter-bolt 34 but again by the bolt 30 whose retraction under the head of the locking part continues (FIG. 12).

The locking part 32 is therefore still held in the unlocking position.

During the closing movement of the door the retracted counter-bolt 34 slides along the door frame 18 and then the keeper 36.

The closing action continues (FIG. 13) and the bolt 30 begins to be deployed from its retracted position when the front face 46 passes the top edge or border 36b of the keeper (FIG. 14). The counter-bolt 34 remains in the retracted position and the locking part 32 is retained in the unlocking position.

When the door is completely closed (FIG. 15), the bolt returns to its first deployed position (bolt out), thereby releasing the locking part 32, which resumes its position locking/immobilizing the bolt as in FIGS. 4a-4b.

For its part, the counter-bolt 34 remains in the retracted position (pushed in) bearing on the top edge of the keeper 36.

The force to open the door and therefore the force to unlock/release the locking and unlocking system 14 is reduced compared to a conventional anti-panic bar mechanism.

In fact, as shown in FIGS. 4a-b and 5, its suffices to unlock/release the bolt 30 by actuating the locking part 32 which forms a pivoting lever.

It will be noted that the locking and unlocking system 14 includes a small number of parts (three parts, namely the bolt 30, the counter-bolt 34 and the locking part 32), which is reflected in a relatively low and economic cost compared to conventional systems.

FIG. 15 illustrates another advantage of the system 14 in accordance with the invention.

The bolt 30 of the system 14 cooperates with a bearing surface (face 36a) of the keeper 36 that is parallel to the surface of the large face 12a of the door. This arrangement enables the system 14 to operate in the same manner (notably the counter-bolt acts in the same manner in cooperation with the keeper and with the bolt and the locking part) over a wide range of adjustment of the clearance J between the frame 18 and the door 12. In the absence of the invention, it is necessary to adjust the position of the keeper so that the counter-bolt and the keeper are positioned correctly. Thanks to the invention, the counter-bolt is active over a greater range of clearance than before. The keeper no longer needs to be adjusted, it sufficing for this that the keeper be of sufficient height.

In accordance with a variant that is not shown, the bearing surface 36a need not be parallel and/or plane.

FIGS. 17 to 19 show another embodiment of the invention in which the system described with reference to the previous figures is applied to locking and unlocking a door in a multi-point version.

FIG. 17 represents the door 12 from FIG. 1 bearing the same references and carrying the system 14 described above.

The system 14 forms part of a locking and unlocking assembly 100 that also includes at the top and at the bottom two respective locking and unlocking systems similar to the system 14 that are connected to said system 14 by a rotary linkage mechanism.

The rotary linkage mechanism includes first and second rotary linkage elements 102, 104 both of which are connected to the respective members 92 (ball supports) equipping the two opposite ends of the linkage element A3/79 of the system 14 from FIGS. 3a-b and 3d. The rotary linkage element 102 (respectively 104) is connected at the top (respectively bottom) to a locking and unlocking system 106, 102 (respectively 108) forming the bottom fixing point.

In FIG. 18 the protective cap of the system 108 is retained whereas that of the system 106 has been removed to show the locking part 132 modified compared to the part 32. The counter-bolt 134 has also been modified.

As shown by way of example in FIG. 19, the locking part 132 includes a head 172 the front end of which intended to come into contact with the keeper 30 remains unchanged. However, the rear end no longer includes a bearing part 78. The part includes a body 170 substantially perpendicular to the head which includes, at the bottom, two legs 170a, 170b that extend upward to form a fork. A tube 180 is equipped at one end with a head 180a that is positioned between the legs 170a-b and is configured to cause pivoting of the locking part 132 about its pivot shaft A2 when said tube is itself driven in rotation about its shaft. The tube is equipped at its opposite end with a member 180b identical to the member 92, namely a ball support, for example. This member 180b is in turn connected to the linkage element 102 which is in line with it.

In this example the counter-bolt bears a central arm 156 the free end of which comes under the locking part in order to prevent the latter impeding the return of the bolt to its first deployed position when it has been deployed into its second position. The system 108 has the same structure as that just described and is connected in exactly the same way to the linkage element 104.

In the position shown in FIG. 17 the door 12 is closed and the systems 14, 106 and 108 are locked.

To unlock the door, the procedure is the same as for the embodiment of FIGS. 1 to 16, involving pressing on the anti-panic bar 16 (or from the other side of the door with a dedicated key).

Upon pivoting movement of the locking part 32 from FIGS. 3a-b and 3d, the widened portion 88a is still retained between the two branches of the fork 90, which drives pivoting of the latter and therefore the shaft A3/bar 79. This pivoting movement of the linkage element A3/79 in turn enables driving in rotation of the other two linkage elements 102, 104 to which each member 92 is respectively connected.

The simultaneous rotation of the linkage elements 102, 104 in turn causes rotation of the tubes 180 of the two systems 106 and 108 (FIG. 19) and therefore pivoting of the locking part 132, which releases the respective bolts 30 of said systems.

Thus the assembly 100 that has just been described includes a rotary linkage system that functions in rotation instead of in translation.

In the conventional way the lengths of the linkages of the multi-point anti-panic mechanisms must be adjusted when fitting them to the door. The top linkages must generally always be cut when fitting them. Thus systematic adjustment of the top link and/or the part that receives it is required.

Thanks to the rotary linkage mechanism described above, the length of the links (within a certain range of lengths) need not be perfectly adapted to the dimensions of the door without this interfering with operation. This therefore eliminates a tiresome adjustment operation at fitting time.

1. System for locking and unlocking an opening panel, the system including:
a mobile bolt (30) that is adapted to be deployed and to be retracted on closing and opening the opening panel (12), the bolt being adapted to occupy a first deployed position when the opening panel is closed and a second deployed position when the opening panel is open,
a mobile locking part (32) that is adapted to cooperate with the bolt,
characterized in that the locking part (32) is designed, on the one hand, to occupy a locking position in which it prevents the bolt (30) moving from its first deployed position to its retracted position in the absence of external action on said part and, on the other hand, to move from its locking position to an unlocking position as a result of the action of an external force in order to enable opening of the opening panel, the system including a mobile counter-bolt (34) that is adapted to be deployed and to be retracted on closing and opening the door, the counter-bolt (34) being adapted to prevent the locking part (32) returning from its unlocking position to its locking position when the bolt (30) is in its second deployed position and the opening panel is open.

2. System according to claim 1, characterized in that, in its retracted position, the bolt (30) is adapted to prevent the locking part (32) returning to its locking position.

3. System according to claim 1, characterized in that the locking part (32) includes a first attachment element (86a) and the counter-bolt (34) includes a second attachment element (56a), the first attachment element being placed on the path of the second attachment element and adapted to come into abutment against it when the counter-bolt moves from its retracted position to its deployed position and the bolt moves to its second deployed position.

4. System according to claim 1, characterized in that the locking part (32) includes a first part (76) adapted to cooperate with the bolt and a second part (78) adapted to receive an external force.

5. System according to claim 1, characterized in that the bolt (30) and the counter-bolt (34) are each mounted on the same first rotation shaft (A1) and are adapted to pivot about the rotation shaft independently of each other over a given angular range of rotation.

6. System according to claim 5, further comprising first spring means (60) that are adapted to exert on the bolt and the counter-bolt a spring force tending to retain them in the deployed position.

7. System according to claim 5, characterized in that the locking part (32) is mounted on a second rotation shaft (A2) parallel to the first rotation shaft and is adapted to pivot about the second rotation shaft.

8. System according to claim 7, further comprising second spring means (82) that are adapted to exert on the locking part (32) a spring force tending to retain it in the locking position.

9. System according to claim 6, further comprising second spring means (82) that are adapted to exert on the locking part (32) a spring force tending to retain it in the locking position, and wherein the first spring means (60) are adapted to exert on the counter-bolt a force greater than the force exerted by the second spring means (82).

10. System according to claim 5, characterized in that at least one of the two elements comprising the bolt (30) and the counter-bolt (34) includes a stop (56b) that is placed on the trajectory of the other element upon pivoting movement of the bolt from a deployed position, the stop (56b) being arranged so that, on the one hand, the bolt and the counter-bolt pivot independently of each other from a deployed position over the given angular range of rotation and, on the other hand, beyond this angular range, the bolt comes into contact with the counter-bolt via the stop and drives said counter-bolt in the continuation of the pivoting movement.

11. System according to claim 1, characterized in that the bolt (30) includes a front face (46) intended to cooperate with a keeper and a so-called immobilizing rear face (62) configured to cooperate with the locking part.

12. System according to claim 11, characterized in that the locking rear face (62) has a concavity that is oriented towards the locking part and centred on a so-called centring shaft for centring the rear face.

13. System according to claim 7, wherein the bolt (30) includes a front face (46) intended to cooperate with a keeper and a so-called immobilizing rear face (62) configured to cooperate with the locking part, and the centring shaft for centring the immobilizing rear face (62) corresponds to the second rotation shaft (A2) of the locking part.

14. System according to claim 11, characterized in that the front face (46) of the bolt has a convexity that is centred on a so-called centring shaft (B1) for centring the front face.

15. System according to claim 14, characterized in that the bolt (30) and the counter-bolt (34) are each mounted on the same first rotation shaft (A1) and are adapted to pivot about the rotation shaft independently of each other over a given angular range of rotation, and the centring shaft (B1) for centring the front face (46) and the first rotation shaft (A1) are offset so as to create a pair of forces enabling closing of the opening panel when the front face of the bolt comes into contact with the keeper and/or the door frame on which the keeper is mounted.

16. System according to claim 11, characterized in that the bolt (30) is hollow and receives the counter-bolt (34) inside it, an opening (45) being provided in the bolt for the counter-bolt pass through to cooperate with the keeper.

17. System according to claim 1, characterized in that, on moving from its locking position to its unlocking position and vice versa, the locking part (32) is adapted to cooperate with a linkage element (79) mounted to rotate about a rotation shaft (A3) in order to cause it to rotate in one direction or the opposite direction.

18. Assembly for locking and unlocking an opening panel, characterized in that it includes at least one locking and unlocking system (14) according to claim 1 and an anti-panic bar (16) associated with said at least one system and actuation of which causes the locking part (32) to move from its locking position to its unlocking position.

19. Assembly for locking and unlocking an opening panel, further comprising a plurality of locking and unlocking systems according to claim 17 that are connected to one another by a rotary linkage mechanism (102, 104) that is actuated by the rotation movement of the rotary linkage element (79).

20. Assembly according to claim 19, characterized in that it includes a first locking and unlocking system (14) disposed substantially in line with an anti-panic bar (16) and two locking and unlocking systems (106, 108) respectively disposed at the top and bottom of the opening panel and each of which is adapted to be unlocked by actuation of the anti-panic bar.
